(19) United States
(12) Patent Application Publication
(10) Pub. No.: US 2024/0278387 A1
(43) Pub. Date: Aug. 22, 2024

(54) SELF-ADAPTIVE SELF-LOCKING CLAMPING APPARATUS

(71) Applicant: Geng Yan, Calgary (CA)

(72) Inventor: Geng Yan, Calgary (CA)

(21) Appl. No.: 18/184,656

(22) Filed: Mar. 16, 2023

Related U.S. Application Data
(60) Provisional application No. 63/447,333, filed on Feb. 21, 2023.

(51) Int. Cl. B25B 5/04; B25B 5/16

(52) U.S. Cl. CPC B25B 5/04; B25B 5/163; B25B 7/04; B25B 7/16

(57) ABSTRACT

The self-adaptive self-locking clamping apparatus comprises a pair of arms pivotally interconnected to each other via a fulcrum either in the middle or on one end of the pair of arms, forming a pair of jaws with at least a variable gap for load, a fulcrum and a pair of handles for effort. The pair of handles engage with each other via a pawl and ratchet mechanism to achieve directional self-locking function, so that the clamping force applied to the pair of handles are maintained after such clamping force is removed. The self-locking pawl and ratchet engagement is self-adaptive to the geometric deformation of the pair of arms resulted from the elastic deformation caused by the clamping force, creating a firm locking grip so that a user does not have to keep maintaining the clamping force while in operation.

### REFERENCE TO RELATED APPLICATIONS

This application claims the benefit of U.S. Provisional Application No. 63/447,333, filed on Feb. 21, 2023.

### FIELD OF THE INVENTION

The present invention relates to a self-adaptive self-locking clamping apparatus that can provide adjustable clamping gap(s), clamping force and self-adaptive self-locking function for applications such as locking clamp, jar opener, oil filter wrench and many others. The present invention offers a variable gap(s) that can be quickly adjusted to adapt to a wide range of sizes of the underlining workpiece the apparatus is operated on, such as lumbers, jar lids and oil filters, and can provide adjustable clamping force and self-locking function. The present invention also offers self-adaptive locking mechanisms to maintain the self-locking engagements when the body of the clamping apparatus is geometrically and elastically deformed under stress.

### BACKGROUND OF THE INVENTION

In many applications such as jar opener, oil filter wrench, wood clamp and many others, the clamping apparatus is required to have a variable clamping gap(s) that can be quickly adjusted to adapt to a wide range of sizes of the underlining workpiece it is operated on, such as the jar lid diameters, oil filter diameters and lumber widths, etc. In such applications the apparatus is also required to provide sustaining clamping force on the underlining workpiece when in operation, so that friction can be generated to firmly lock the workpiece in a position, such as in the wood clamp application; or for twisting operation, such as in the jar opener and oil filter wrench applications. This creates the needs for a clamping apparatus that can provide a quick clamping gap and force adjustment, as well as a self-locking mechanism so that a user does not have to keep applying the clamping force while in operation. The self-locking mechanism is especially beneficial to a wide range of users who either have weak hand grip due to old age or illnesses such as arthritis, or do not have the dexterity to coordinate applying proper clamping force while operating the apparatus.

In the application as wood clamp, which employs scissor linkage connection so that it has a fulcrum in the middle of the body and the load and effort are distributed on both sides of the fulcrum, there are devices exist in prior art and commercially available tools utilizing circular movement pawl and ratchet self-locking mechanisms similar to this invention. However, there is a major issue of these devices to prevent them from being effectively used in real life, which is the geometric elastic deformation of the clamping device caused by the clamping force may destabilize the pawl and ratchet self-locking mechanism, due to that the required circular movement path of the self-locking parts cannot maintain constant. As the result the self-locking parts may either jam or disengage when the device is undergoing significant stress and geometric deformation. In the applications of jar opener and oil filter wrench, due to that these devices have the fulcrum located on one end and the load and effort on the other end, which further exacerbates the deformation issue, no similar self-locking means are currently utilized and people conventionally rely on open-end clamping mechanism without self-locking function in the jar opener application, and strap type wrench or plier wrench in the oil filter wrench application.

Therefore, there are strong needs for this invention that can provide quick adjustable clamping gap and clamping force, and self-adaptive self-locking mechanisms to maintain the clamping gap and clamping force even under stress and deformation.

### SUMMARY OF THE INVENTION

The primary object of the present invention is to provide self-adaptive self-locking mechanisms that can offer quick clamping gap and force adjustment and self-adaptive self-locking function.

The second object is to provide a self-adaptive self-locking mechanism via an integrated pawl and ratchet locking mechanism for applications that require high clamping force.

The other object is to provide a self-adaptive self-locking mechanism via an individual pawl and ratchet locking mechanism for applications that require significantly high clamping force so that the load can be evenly distributed among multiple pawl and ratchet teeth.

To the accomplishment of the above and related objects, this invention may be embodied in the preferred embodiments illustrated in the accompanying drawings. It should be noted however, that the drawings are illustrative only, and that various embodiments can be made to achieve the same objectives.

### BRIEF DESCRIPTION OF DRAWINGS

Various other objects, features and advantages of the present invention will become fully appreciated and better understood when considered in conjunction with the accompanying drawings, wherein for the preferred embodiments:

FIG. 1 is a perspective view of a preferred embodiment of a self-adaptive self-locking clamping apparatus in the application as a locking clamp (referred to as locking clamp hereon).

FIG. 2 is a perspective view of the locking clamp of FIG. 1 from an opposite direction.

FIG. 3 is an exploded view of the locking clamp of FIG. 1.

FIG. 4 is a combination of orthographic and sectional views of the locking clamp of FIG. 1.

FIG. 5 is perspective view of a first arm that may be used on the locking clamp of FIG. 1.

FIG. 6 is a perspective view of a second arm that may be used on the locking clamp of FIG. 1.

FIG. 7 is a perspective view of an integrated pawl trigger that may be used on the locking clamp of FIG. 1.

FIG. 8 is a perspective view of a ratchet arc that may be used on the locking clamp of FIG. 1.

FIG. 9 is a sectional view of the locking clamp of FIG. 1 to illustrate the self-locking mechanism when the locking clamp is clamped on a piece of lumber in an ideal situation, of which no geometric deformation of the locking clamp occurs.

FIG. 10 is a sectional view of the locking clamp of FIG. 1 to illustrate the self-adaptive self-locking mechanism when the locking clamp is clamped on the piece of lumber in a real-life situation, of which geometric deformation of the locking clamp occurs.

FIG. 11 is a perspective view of a preferred embodiment of a self-adaptive self-locking clamping apparatus in the application as a jar opener (referred to as jar opener hereon).

FIG. 12 is a perspective view of the jar opener of FIG. 11 from an opposite direction.

FIG. 13 is an exploded view of the jar opener of FIG. 11.

FIG. 14 is a combination of orthographic and sectional views of the jar opener of FIG. 11.

FIG. 15 is a perspective view of a first arm that may be used on the jar opener of FIG. 11.

FIG. 16 is a perspective view of a second arm that may be used on the jar opener of FIG. 11.

FIG. 17 is a perspective view of an integrated pawl trigger that may be used on the jar opener of FIG. 11.

FIG. 18 is a perspective view of a ratchet arc that may be used on the jar opener of FIG. 11.

FIG. 19 is a perspective view to illustrate how the jar opener of FIG. 11 is operated on a jar lid.

FIG. 20 is a sectional view of FIG. 19 to illustrate the self-locking mechanism when the jar opener is operated on the jar lid in an ideal situation, of which no geometric deformation of the jar opener occurs.

FIG. 21 is a sectional view of FIG. 19 to illustrate the self-adaptive self-locking mechanism when the jar opener is operated on the jar lid in a real-life situation, of which geometric deformation of the jar opener occurs.

FIG. 22 is a perspective view of a preferred embodiment of a self-adaptive self-locking clamping apparatus in the application as an oil filter wrench (referred to as oil filter wrench hereon).

FIG. 23 is a perspective view the oil filter wrench of FIG. 22 from an opposite direction.

FIG. 24 is an exploded view of the oil filter wrench of FIG. 22.

FIG. 25 a combination of orthographic and sectional views of the oil filter wrench of FIG. 22.

FIG. 26 is a perspective view of a first arm that may be used on the oil filter wrench of FIG. 22.

FIG. 27 is a perspective view of a second arm that may be used on the oil filter wrench of FIG. 22.

FIG. 28 is a perspective view of a linkage trigger that may be used on the oil filter wrench of FIG. 22.

FIG. 29 is a perspective view of a pawl that may be used on the oil filter wrench of FIG. 22.

FIG. 30 is a perspective view of a ratchet arc that may be used on the oil filter wrench of FIG. 22.

FIG. 31 is a perspective view to illustrate how the oil filter wrench of FIG. 22 is utilized to tighten an oil fitter.

FIG. 32 is a perspective view to illustrate how the oil filter wrench of FIG. 22 is utilized to loosen the oil fitter.

FIG. 33 is a hybrid sectional view of the oil filter wrench and projection view of the oil filter of FIG. 32 to illustrate the self-locking mechanism when the oil filter wrench is operated on the oil filter in an ideal situation, of which no geometric deformation of the oil filter wrench occurs.

FIG. 34 is a hybrid sectional view of the oil filter wrench and projection view of the oil filter of FIG. 32 to illustrate the self-adaptive self-locking mechanism when the oil filter wrench is operated on the oil filter in a real-life situation, of which geometric deformation of the oil filter wrench occurs.

### DETAILED DESCRIPTION OF THE INVENTION

Described below are the preferred embodiments of the present invention, which illustrate ways in which the invention may be implemented. Although the embodiments shown are described in the context of locking clamp, jar opener and oil filter wrench, the invention can also be used in many other applications that will benefit from sustaining clamping force with a self-adaptive self-locking function, such as lemon squeezer and many others. In the descriptions that follow, the preferred embodiments are disclosed in detail to illustrate the principles of the invention. Therefore, it should be noted that the preferred embodiments are merely respective forms of the many potential embodiments in many applications, and the structural and functional details described herein are not intended to be limiting of the invention, but merely serve as the exemplary representations and the principles of the present invention.

In the disclosure the same reference characters represent the same elements in all figures. The references of “up”, “down”, “upper”, “lower”, “top”, “bottom”, “vertical”, “horizontal”, “front”, “rear” and so on are based on the positions shown on the views. Terms like “first”, “second”, “third”, “forth”, “last”, “one”, “another”, “on one end”, “on the other end” and so on are used to arbitrarily distinguish the elements in relation to the position and/or the sequence of a description or illustration. On the figures with combination of orthographic, sectional and perspective views, the reference characters may not be indicated to avoid reducing legibility of the drawing details, however the components will become obvious on the other views.

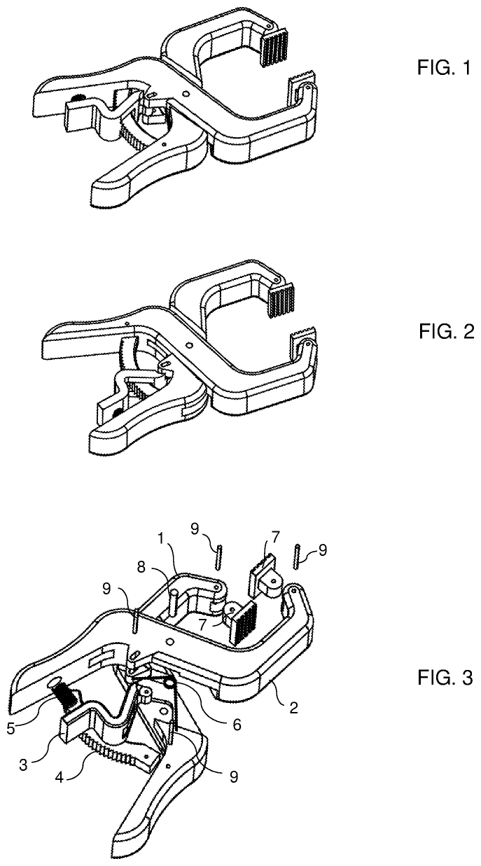

FIG. 1 and FIG. 2 illustrate a self-adaptive self-locking clamping apparatus in an open position in a preferred embodiment as a locking clamp.

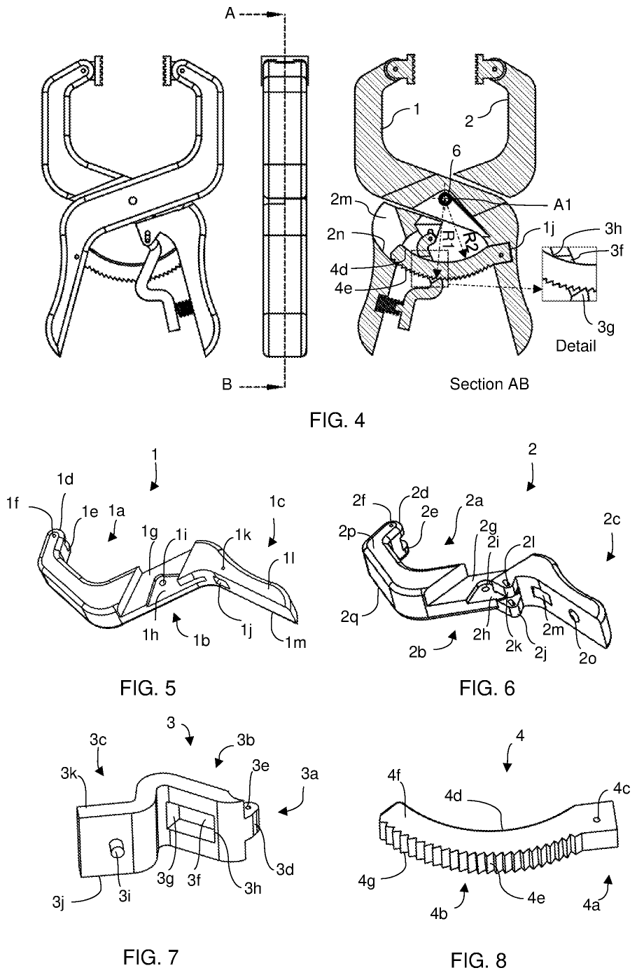

FIG. 3 and FIG. 4 further show how the locking clamp is constructed. The locking clamp may comprise a first arm 1, a second arm 2, an integrated pawl trigger 3, a ratchet arc 4, a compression spring 5, a torsion spring 6, a pair of clamp heads 7, and a plurality of pins 8 and 9.

The first arm 1 (FIG. 3, FIG. 4, FIG. 5) may have a similar to stretched “S” shape longitudinal body having a jaw section 1a on one end, connected by a pivot section 1b in the middle, followed by a handle section 1c on the other end. The longitudinal edges 1l and 1m define the width of the first arm 1. A pair of spaced apart hinge seats 1d and 1e generally parallel and symmetric to the center plane AB (FIG. 4) are disposed at the end of the jaw section 1a. A bore hole 1f generally perpendicular to the plane AB is bored through the pair of hinge seats 1d and 1e to pivotally receive a clamp head 7 via a first pin 9 (FIG. 3). The pivot section 1b may further comprise a step-down coupling surface 1g offset from the longitudinal edge 1l to couple with corresponding coupling surface of the second arm 2 to form a scissor linkage, a similar to “V” shape recess 1h to receive the torsion spring 6, and a bore hole 1i generally perpendicular to the plane AB and through the recess 1h to pivotally connect with the torsion spring 6 and coaxially aligned with the corresponding bore hole on the second arm 2 to form a spring pivot and a fulcrum via a pin 8. The handle section 1c may further comprise a recess 1j sized and shaped to stationarily receive the anchor end of the ratchet arc 4, and a bore hole 1k generally perpendicular to the plane AB and through the recess 1j to fix the ratchet arc 4 in place via a second pin 9.

The second arm 2 (FIG. 3, FIG. 4, FIG. 6) may have a similar shape body as the first arm 1, which may comprise a jaw section 2a on one end, a pivot section 2b in the middle and a handle section 2c on the other end. The longitudinal edges 2p and 2q define the width of the second arm 2. A pair of spaced apart hinge seats 2d and 2e generally parallel and symmetric to the center plane AB (FIG. 4) are disposed at the end of the jaw section 2a. A bore hole 2f generally perpendicular to the plane AB is bored through the pair of hinge seats 2d and 2e to pivotally receive another clamp head 7 via a third pin 9 (FIG. 3). The pivot section 2b may further comprise a step-down coupling surface 2g offset from the longitudinal edge 2p to couple with the corresponding coupling surface 1g of the first arm 1 to form the scissor linkage, a similar to “V” shape recess 2h to pair up with the recess 1h to receive the torsion spring 6, and a bore hole 2i generally perpendicular to the plane AB and through the recess 2h to coaxially align with the corresponding bore hole 1i and pivotally connect with the torsion spring 6 to form the spring pivot and the fulcrum via the pin 8. The handle section 2c may further comprise a pair of spaced apart transversely protruding hinge seats 2k and 2j adjacent to the pivot section 2b, a slot 21 generally perpendicular to the plane AB cutting through the pair of hinge seats 2k and 2j to pivotally and slidably receive a fourth pin 9, a transverse pathway 2m, and a transverse circular recess 20 to stationarily received one end of the compression spring 5. The pathway 2m is designed in the way that a bottom arc surface 2n (FIG. 4) having a radius R1 that is centered on the axis A1 may slidably receive the ratchet arc 4.

The integrated pawl trigger 3 (FIG. 3, FIG. 4, FIG. 7) may have a similar to trigger shape curvy longitudinal body comprising a hinge seat section 3a, an integrated pawl section 3b and a lever section 3c. The longitudinal edges 3j and 3k define the width of the integrated pawl trigger 3. The hinge seat section 3a having a hinge seat 3d offset from both longitudinal edges 3k and 3j and a bore hole 3e generally perpendicular to the plane AB (FIG. 4) is sized and shaped to be received into the gap between the pair of hinge seats 2k and 2j and in conjunction with the fourth pin 9 and the slot 21 to form a variable pivot, via which the integrated pawl trigger 3 pivots on the axis of the fourth pin 9, while the fourth pin 9 may movably slide in the slot 21. The travel limit pin and slot mechanism allows the integrated pawl trigger 3 to move up and down and rotate to self-adapt to the ratchet arc 4's movement resulted from the geometric deformation of the first and second arms 1 and 2 that is caused by the compressing force, so as to achieve the self-adaptive self-locking function. The integrated pawl section 3b may further comprise a transverse pathway 3f to slidably receive the ratchet arc 4, via which on the side adjacent to the lever section 3c an integral pawl tooth 3g and on the opposite side a compressing edge 3h that is generally perpendicular to the plane AB and significantly parallel to the edge of the integral pawl tooth 3g are also formed. The lever section 3c may further comprise a transversely protruding cylinder 3i to be stationarily received into another end of the compression spring 5.

In the preferred embodiment a single pawl tooth 3g is integrated to the integrated pawl trigger 3, however in other embodiments multiple pawl teeth may be integrated or mounted to the integrated pawl trigger 3.

The ratchet arc 4 (FIG. 3, FIG. 4, FIG. 8) may have a similar to arc shape longitudinal body comprising an anchor end 4a and a ratchet section 4b. The longitudinal edges 4f and 4g define the width of the body. The anchor end 4a having a bore hole 4c generally perpendicular to the plane AB (FIG. 4) is sized shaped to be stationarily received into the recess 1j and anchored on the first arm 1 via the coaxially aligned bore holes 1k and 4c, and the second pin 9. The ratchet section 4b may further comprise a lateral arc surface 4d having a radius R2 that is centered on the axis A1 when assembled, and a lateral arc integral ratchet face 4e having a radius R1 that is centered on the axis A1 when assembled (FIG. 4). The ratchet section 4b is sized and shaped to smoothly slide through the pathway 3f and the pathway 2m (FIG. 4).

In the assembled form, the coupled pivot section 1b and 2b in conjunction with the torsion spring 6 and the pin 8 form the scissor linkage spring pivot and the fulcrum on the axis A1 (FIG. 4); the jaw sections 1a and 2a pair up to form a pair of jaws with a variable gap to clamp on a workpiece; the handle sections 1c and 2c pair up to form a pair of handles to exert compressing force; the torsion spring 6 exerts spring force on the pair of handles to push the pair of handles apart; the integrated pawl trigger 3 is pivotally connected to the second arm 2 in the slot 21 and pivots at the bottom of the slot 21; the ratchet arc 4 is slidably received into the integrated pawl trigger 3 and the second arm 2; and the compression spring 5 supported between the second arm 2 and the integrated pawl trigger 3 exerts spring force on the integrated pawl trigger 3 so that the integrated pawl trigger 3 rotates away from the second arm 2 until the compressing edge 3h grips on the arc surface 4d on one side, and the integral pawl tooth 3g fully engages with the integral ratchet face 4e on the opposite side, therefore creates a pawl and ratchet self-locking mechanism. When a user exerts compressing force to the pair of handles, the ratchet arc 4 pushes the integrated pawl trigger 3 to rotate closer to the second arm 2 to disengage the pawl and ratchet engagement and slides further forward into the pathway 2m, resulting the gap of the pair of jaws to narrow. When the exerted compressing force is removed, the compression spring 5 pushes the integrated pawl trigger 3 to rotate away from the second arm 2, forcing the compressing edge 3h to grip on the arc surface 4d and the integral pawl tooth 3g to fully engage with the integral ratchet face 4e, and preventing the ratchet arc 4 from sliding backward. Therefore, the locking clamp is self-locked in a fixed position. When the integrated pawl trigger 3 is pulled closer to the handle section 2c, the compressing edge 3h and the integral pawl tooth 3g are lifted away from the arc surfaces 4d and integral ratchet face 4e so that the pawl and ratchet disengage, and the torsion spring 6 pushes the pair of handles further apart until the pair of jaws reach a maximum gap.

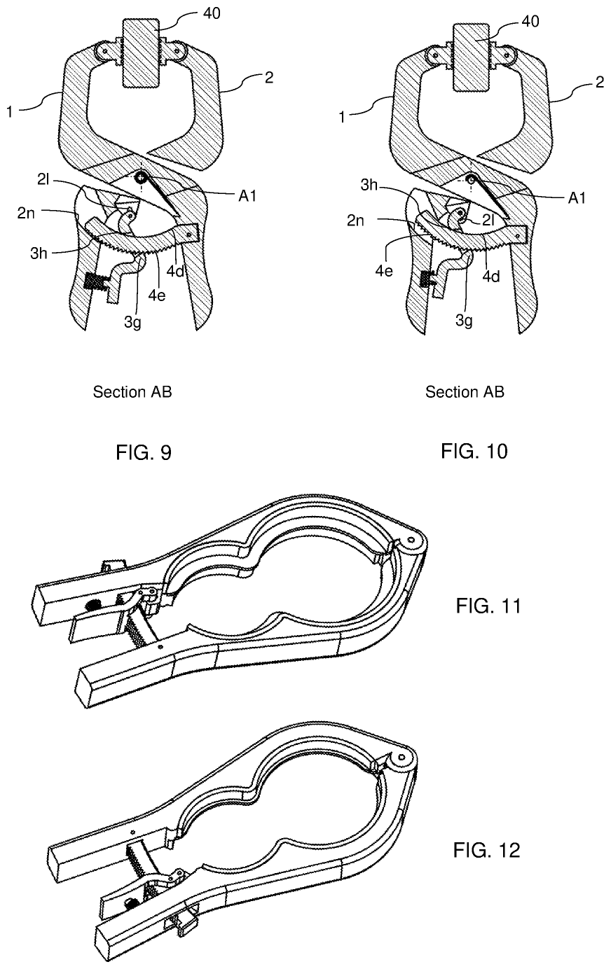

FIG. 9 and FIG. 10 further illustrate how the self-adaptive self-locking mechanism works when the locking clamp is firmly clamped on a workpiece such as a piece of lumber 40 and the sustaining clamping force is maintained after the clamping force exerted by a user is removed. FIG. 9 shows a sectional view from the same plane AB on the FIG. 4 of an ideal situation, in which no geometric deformation occurs to both of the first and second arms 1 and 2. In such situation the ratchet arc 4 slides forward along the arc surface 2n in a circular motion in relation to the axis A1 and the pawl trigger 3 pivots in a bottom pivot position in the slot 21. FIG. 10 shows a sectional view from the same plane AB on the FIG. 4 of a real-life situation, in which geometric deformation occurs to both of the first and second arms 1 and 2 due to material elastic deformation under stress. In such situation the handle sections 1c and 2c are bent inwards, the ratchet arc 4 is tilted up away from the arc surface 2n and the integrated pawl trigger 3 is pushed up away from the bottom pivot position to pivot in another position in the slot 21, self-adapting to the ratchet arc 4's movement while maintaining the pawl and ratchet engagement, therefore the majority of the previously exerted clamping energy is stored in the form of elastic deformation of the first and second arm 1 and 2, and the strong grip on the underlining workpiece is maintained.

FIG. 11 and FIG. 12 illustrate a self-adaptive self-locking clamping apparatus in an open position in a preferred embodiment as a jar opener.

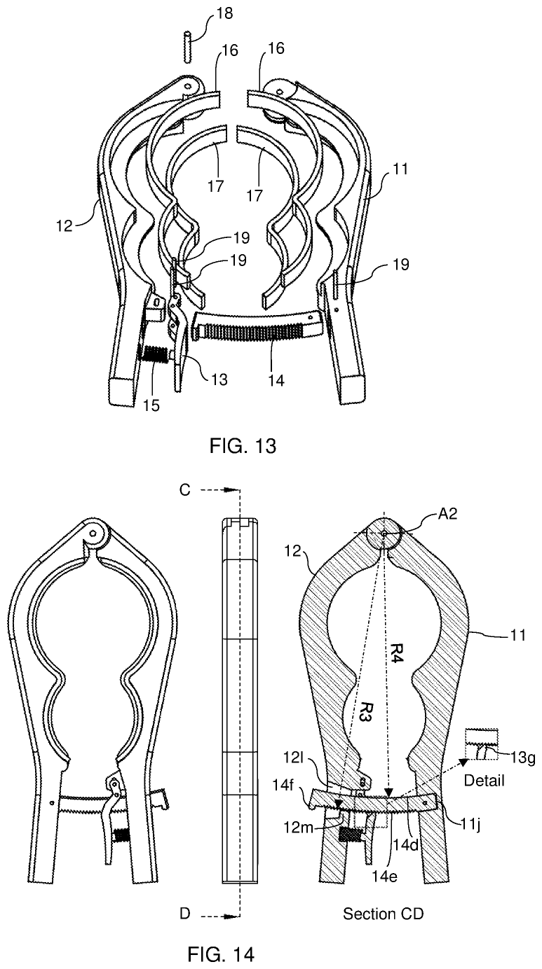

FIG. 13 and FIG. 14 further show how the jar opener is constructed. The jar opener may comprise a first arm 11, a second arm 12, an integrated pawl trigger 13, a ratchet arc 14, a compression spring 15, a pair of first clamping pads 16, a pair of second clamping pads 17, and a plurality of pins 18 and 19.

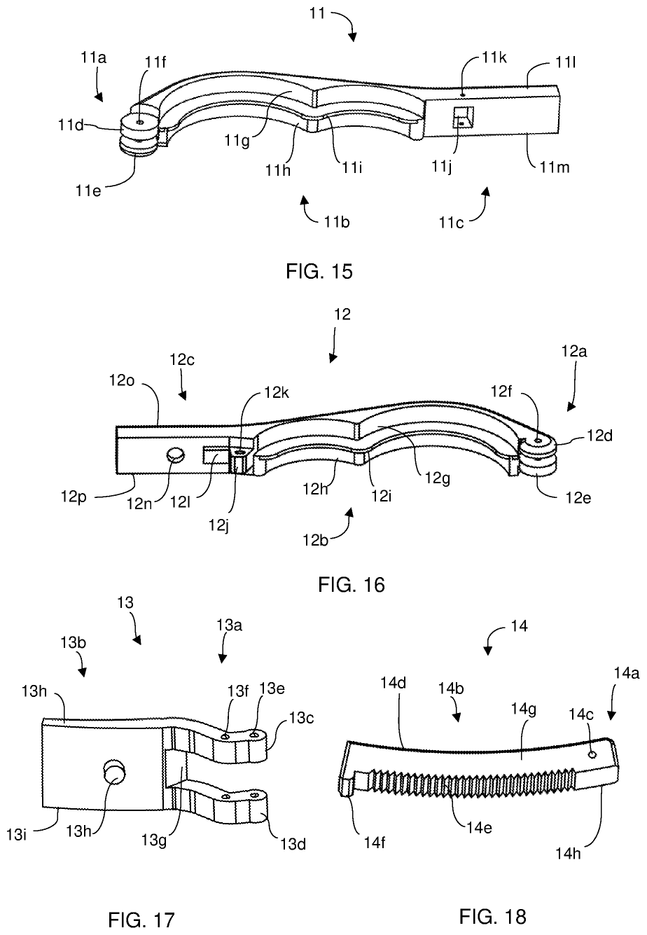

The first arm 11 (FIG. 13, FIG. 14, FIG. 15) may have a curved longitudinal body, which may comprise a pivot section 11a on one end, connected by a twin jaw section 11b in the middle, followed by a handle section 11c on the other end. The longitudinal edges 111 and 11m define the width of the body. The pivot section 11a may further comprise a pair of spaced apart hinge seats 11d and 11e sized and shaped to couple with a corresponding pair of hinge seats on the second arm 12 to form a first pivot and a fulcrum, and a bore hole 11f generally perpendicular to the plane CD (FIG. 14) and though the pair of hinge seats 11d and 11e to pivotally receive a pin 18. The twin jaw section 11b may further comprise a first twin curved lateral surface 11g, a transverse twin curved reinforcement ridge 11i and a second twin curved lateral surface 11h stacking side-by-side width-wise. The first and second twin curved surfaces 11g and 11h are designed to couple with corresponding twin curved surfaces of the second arm 12, to form a pair of jaws with multiple variable gaps to cover the majority of commonly used standard and non-standard jar lid or container lid sizes, so that a single jar opener can act as a universal jar opener. The twin reinforcement ridge 11i is designed to enhance the rigidity of the first arm 11 and reduce geometric deformation when operated on a workpiece, and also act as supporting surfaces for a jar lid or container lid to enhance the friction between the jar lid or container lid and the jar opener and the stability of the operation. The twin reinforcement ridge 11i may be further coated with high friction material such as rubber to further enhance the stability and friction. The handle section 11c may further comprise a recess 11j sized and shaped to stationarily receive the anchor end of the ratchet arc 14, and a bore hole 11k generally perpendicular to the plane CD and through the recess 11j to fix the ratchet arc 14 in place via a first pin 19.

The second arm 12 (FIG. 13, FIG. 14, FIG. 16) may have a similar shape body as the first arm 11, which may comprise a pivot section 12a on one end, a twin jaw section 12b in the middle and a handle section 12c on the other end. The longitudinal edges 120 and 12p define the width of the body. The pivot section 12a may further comprise a pair of spaced apart hinge seats 12d and 12e sized and shaped to couple with the corresponding pair of hinge seats 11d and 11e on the first arm 11 to form the first pivot and the fulcrum, and a bore hole 12f generally perpendicular to the plane CD (FIG. 14) and though the pair of hinge seats 12d and 12e to coaxially align with the bore hole 11f and pivotally receive the pin 18. The twin jaw section 12b may have identical structure and functionality as the corresponding twin jaw section 11b, which may comprise a first twin curved lateral surface 12g, a transverse twin curved reinforcement ridge 12i and a second twin curved lateral surface 12h stacking side-by-side width-wise. The handle section 12c may further comprise a transversely protruding hinge seat 12j adjacent to the twin jaw section 12b with both longitudinal edges offset from the longitudinal edges 120 and 12p, a slot 12k disposed generally along the longitudinal direction and perpendicular to the plane CD cutting through the hinge seats 12j to pivotally and slidably receive a second pin 19, a transverse pathway 121 adjacent to the hinge seat 12j to slidably receive the ratchet arc 14, and a transverse circular recess 12n to stationarily received one end of the compression spring 15. The pathway 121 is designed in the way that the pathway entry may have a threshold 12m (FIG. 14) to allow the ratchet arc 14 rest on and restrain the ratchet arc 14 from sliding backward out of the pathway.

The integrated pawl trigger 13 (FIG. 13, FIG. 14, FIG. 17) may have a similar to trigger shape curvy longitudinal body comprising a hinge seat section 13a and an integrated pawl lever section 13b. The longitudinal edges 13h and 13i define the width of the body. The hinge seat section 13a may further comprise a pair of forked arms 13c and 13d forked along the longitudinal edges 13h and 13i from the integrated pawl lever section 13b and generally symmetric to the plane CD (FIG. 14), a first bore hole 13e on the end of the hinge seat section 13a generally perpendicular to the plane CD and through the pair of the forked arms 13c and 13d, and a second bore hole 13f in the middle generally parallel to the first bore hole 13e and through the pair of the forked arms 13c and 13d. The pair of forked arms 13c and 13d may couple with the hinge seat 12j and the bore hole 13e may align with the slot 12k to stationarily receive the second pin 19 to form a variable pivot, via which the integrated pawl trigger 13 pivots on the axis of the second pin 19, while the second pin 19 may movably slide in the slot 12k. The second bore hole 13f may stationarily receive a third pin 19 to form a compressing edge for the integrated pawl trigger 13 and a pathway for the ratchet arc 14. The travel limit pin and slot mechanism allows the integrated pawl trigger 13 to move up and down and rotate to self-adapt to the ratchet arc 14's movement resulted from the geometric deformation of the first and second arms 11 and 12 that is caused by the compressing force, so as to achieve the self-adaptive self-locking function. The integrated pawl lever section 13b may further comprise an integral pawl tooth 13g adjacent to and between the pair of forked arms 13c and 13d, and a transversely protruding cylinder 13h in the middle to be stationarily received into the other end of the compression spring 15. The space enclosed by the pair of forked arms 13c and 13d, the third pin 19 and the integral pawl tooth 13g form a pathway to slidably receive the ratchet arc 14.

In the preferred embodiment a single pawl tooth 13g is integrated to the integrated pawl trigger 13, however in other embodiments multiple pawl teeth may be integrated or mounted to the integrated pawl trigger 13.

The ratchet arc 14 (FIG. 13, FIG. 14, FIG. 18) may have a similar to arc shape longitudinal body comprising an anchor end 14a and a ratchet section 14b. The longitudinal edges 14g and 14h define the width of the body. The anchor end 14a having a bore hole 14c generally perpendicular to the plane AB (FIG. 4) is sized shaped to be stationarily received into the recess 11j and anchored on the first arm 11 via the coaxially aligned bore holes 11k and 14c, and the first pin 19. The ratchet section 14b may further comprise a lateral arc surface 14d having a radius R4 that is centered on the axis A2 when assembled, a lateral arc integral ratchet face 14e having a radius R3 that is centered on the axis A2 when assembled (FIG. 14), and a transversely protruding stop ridge 14f at the end which in conjunction with the threshold 12m (FIG. 14) restrain the ratchet arc 14 from sliding backward out of the pathway 121. The ratchet section 14b is sized and shaped to smoothly slide through the pathway between the integrated pawl tooth 13g and the third pin 19 in the bore hole 13f, and the pathway 121 (FIG. 14).

The pair of first clamping pads 16 and the pair of second clamping pads 17 may be made of high friction and elastic material, such as rubber, and fused or bonded to the first and second twin curved surface 11g and 11h of the first arm 11, as well as the first and second twin curved surface 12g and 12h of the second arms 12 via suitable means. The clamping pads are employed to minimize the deformation of the workpiece and enhance friction for twisting operation.

In the assembled form, the pivot section 11a and 12a in conjunction with the pin 18 form the first pivot and the fulcrum on the axis A2 (FIG. 14); the twin jaw sections 11b and 12b pair up to form a pair of twin jaws with multiple variable gaps to clamp on a workpiece; the handle sections 11c and 12c pair up to form a pair of handles to exert compressing force; the integrated pawl trigger 13 is pivotally connected to the second arm 12 and pivots at the bottom of the slot 12k; the ratchet arc 14 is affixed to the first arm 11 on the anchor end 14a, and the ratchet section 14b is slidably received into the pathway between the integral pawl tooth 13g and the third pin 19 and the pathway 121, and rests on the threshold 12m; the compression spring 15 supported between the second arm 12 and the integrated pawl trigger 13 exerts spring force on the integrated pawl trigger 13 so that the integrated pawl trigger 13 rotates away from the second arm 12 until the third pin 19 grips on the arc surface 14d on one side, and the integral pawl tooth 13g fully engages with the integral ratchet face 14e on the opposite side, therefore creates a pawl and ratchet self-locking mechanism. When a user exerts compressing force on the pair of handles, the ratchet arc 14 pushes the integrated pawl trigger 13 to rotate closer to the second arm 12 to disengage the pawl and ratchet engagement and slides forward further into the pathway 121, resulting in the gaps of the pair of jaws to narrow. When the exerted compressing force is removed, the compression spring 15 pushes the integrated pawl trigger 13 to rotate away from the second arm 12, forcing the integral pawl tooth 13g to fully engage with the integral ratchet face 14e and the third pin 19 to grip on the arc surface 14d, and preventing the ratchet arc 14 from sliding backward. Therefore, the jar opener is self-locked in a fixed position. When the integrated pawl trigger 13 is pulled closer to the second arm 12, the third pin 19 and the integral pawl tooth 13g are lifted away from the arc surfaces 14d and integral ratchet face 14e, so that the pawl and ratchet disengage, allowing the pair of handles to move apart.

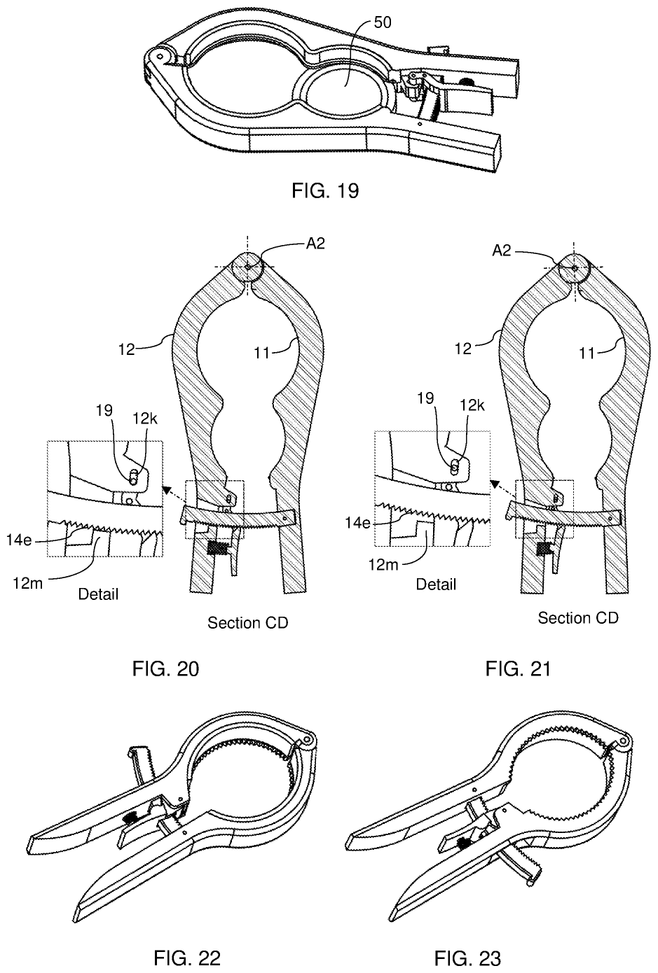

FIG. 19 illustrates how the jar opener is operated to open a jar lid 50 (the jar body is not shown). A user may place the jar lid 50 between the pair of twin jaws, and exert clamping force on the pair of handles. The clamping force forces the gaps between the pair of twin jaws to narrow, resulting in the jar lid rim in contact with either the pair of first clamping pads 16 or the pair of second clamping pads 17 and the jar lid top in contact with one side of the reinforcement ridges 11i and 12i. The user may further exert clamping force on the pair of handles to force the corresponding elastic pair of clamping pads and the pair of first and second arms 11 and 12 to deform, creating a strong grip on the jar lid. The user may then turn the pair of the first and second arms 11 and 12 on a desired location, and utilize the resulting friction force exerted on the jar lid to disengage the jar lid from the jar, while not having to keep exerting the clamping force.

FIG. 20 and FIG. 21 further illustrate how the self-adaptive self-locking mechanism works in the abovementioned operating example of FIG. 19. FIG. 20 shows a sectional view of the FIG. 19 from the same plane CD on the FIG. 14 of an ideal situation, in which no geometric deformation occurs to both of the first and second arm 11 and 12. In such situation the ratchet arc 14 slides along the threshold 12m in a circular motion in relation to the axis A2, and the integrated pawl trigger 13 pivots in a bottom position in the slot 12k. FIG. 21 shows a sectional view of the FIG. 19 from the same plane CD on the FIG. 14 of a real-life situation, in which geometric deformation occurs to both of the first and second arm 11 and 12 due to material elastic deformation under stress. In such situation the handle sections 11c and 12c are bent inwards, the ratchet arc 14 is tilted up away from the threshold 12m and the integrated pawl trigger 13 is pushed up away from the bottom pivot position to pivot in another position in the slot 12k, self-adapting to the ratchet arc 14's movement caused by the geometric deformation of both the first and second arms 11 and 12 while maintaining the pawl and ratchet engagement. Therefore, the majority of the previously exerted clamping energy is stored in the form of elastic deformation of the pair of first and second arms 11 and 12, and either the pair of first clamping pads 16 or the pair of second clamping pads 17, and the strong grip on the underlining workpiece is maintained.

FIG. 22 and FIG. 23 illustrate a self-adaptive self-locking clamping apparatus in an open position in a preferred embodiment as an oil filter wrench.

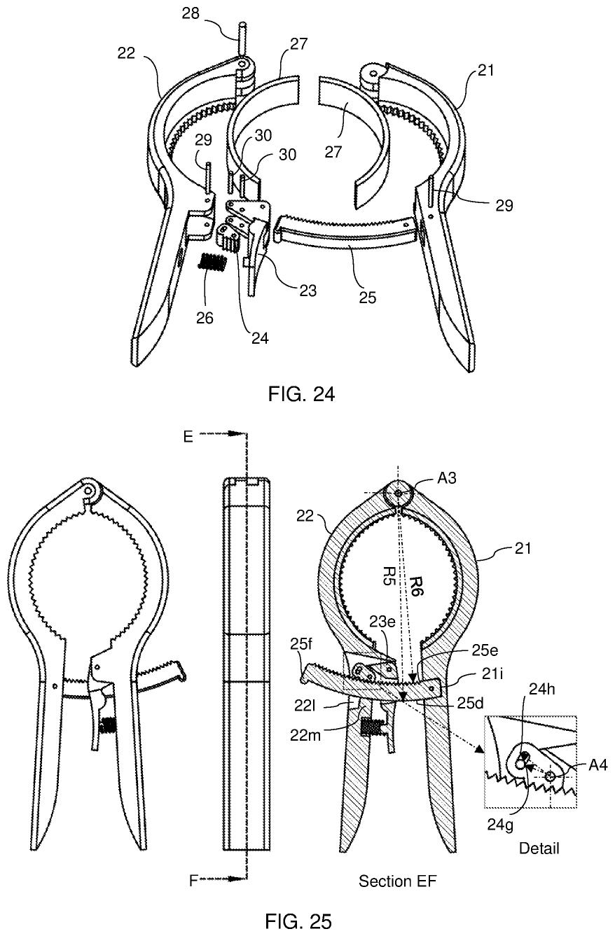

FIG. 24 and FIG. 25 further show how the oil filter wrench is constructed. The oil filter wrench may comprise a first arm 21, a second arm 22, a linkage trigger 23, a pawl 24, a ratchet arc 25, a compression spring 26, a pair of clamping pads 27, and a plurality of pins 28, 29 and 30.

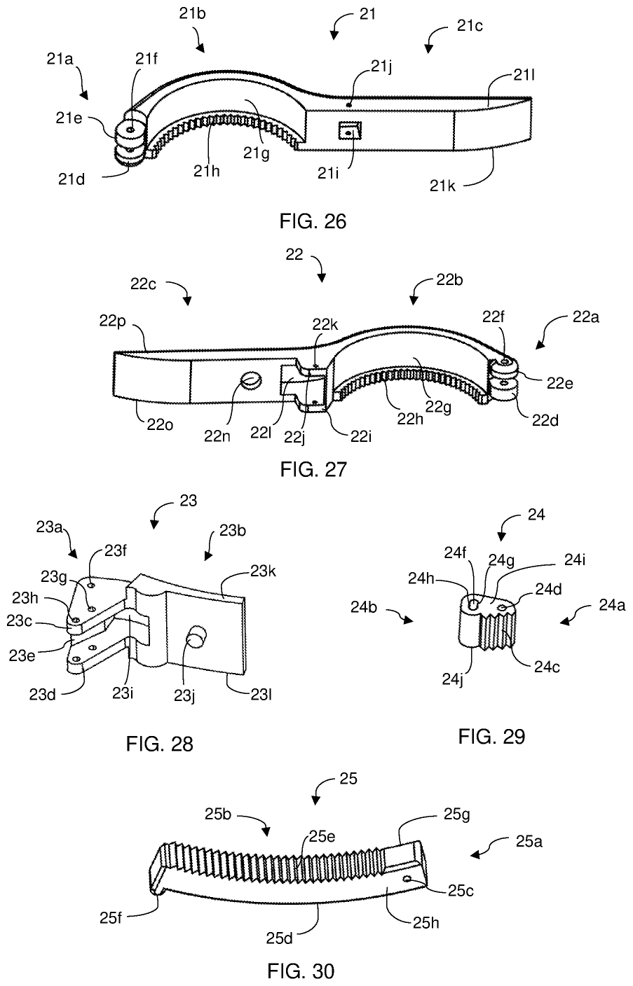

The first arm 21 (FIG. 24, FIG. 25, FIG. 26) may have a curved longitudinal body, which may comprise a pivot section 21a on one end, connected by a jaw section 21b in the middle, followed by a handle section 21c on the other end. The longitudinal edges 211 and 21k define the width of the body. The pivot section 21a may further comprise a pair of spaced apart hinge seats 21d and 21e sized and shaped to couple with a corresponding pair of hinge seats on the second arm 22 to form a first pivot and a fulcrum, and a bore hole 21f generally perpendicular to the plane EF (FIG. 25) and though the pair of hinge seats 21d and 21e to pivotally receive a pin 28. The jaw section 21b may comprise a curved lateral surface 21g and a curved transversely protruding toothed arc 21h stacking side by side width-wise. The curved surface 21g and toothed arc 21h are designed to pair up with corresponding curved surface and toothed arc on the second arm 22, to form a variable elastic gap and a variable hard-toothed gap to cover a range of commonly used oil filter sizes. The curved surface 21g is designed to bond or fuse with a high friction and elastic clamping pad 27, so that in tightening operation a user may clamp an oil filter in this elastic gap to twist the last a quarter of a turn after the oil filter is hand-tightened, without damaging the oil filter housing. The toothed arc 21h is designed to dent the oil filter housing so that a user may use this section in conjunction with the pair of clamping pads 27 to loosen the oil filter with enhanced grip. The handle section 21c may comprise a recess 21i sized and shaped to stationarily receive the anchor end of the ratchet arc 25, and a bore hole 21j generally perpendicular to the plane EF and through the recess 21i to fix the ratchet arc 25 in place via a first pin 29.

The second arm 22 (FIG. 24, FIG. 25, FIG. 27) may have a similar shape body as the first arm 21, which may comprise a pivot section 22a on one end, a jaw section 22b in the middle and a handle section 22c on the other end. The longitudinal edges 220 and 22p define the width of the body. The pivot section 22a may further comprise a pair of spaced apart hinge seats 22d and 22e sized and shaped to couple with the pair of hinge seats 21d and 21e on the first arm 21 to form the first pivot and the fulcrum, and a bore hole 22f generally perpendicular to the plane EF (FIG. 25) and though the pair of hinge seats 22d and 22e to coaxially align with the bore hole 21f and pivotally receive the pin 28. The jaw section 22b may have identical structure and functionality as the corresponding jaw section 21b, which may comprise a lateral curved surface 22g and a curved transversely protruding toothed arc 22h stacking side by side width-wise. The handle section 22c may further comprise a pair transversely protruding hinge seat 22i and 22j spaced a part along the longitudinal edges 220 and 22p and bridged on the jaw section 22b side, a bore hole 22k generally perpendicular to the plane EF and though the pair of hinge seats 22i and 22j to pivotally receive a second pin 29, a transverse pathway 221 extended from the opening between the pair of hinge seats 22i and 22j and cutting through the handle section 22c to slidably receive the ratchet arc 25, and a transverse circular recess 22n to stationarily receive one end of the compression spring 26. The pathway 221 is designed in the way that the pathway entry may have a threshold 22m (FIG. 25) to allow the ratchet arc 25 to rest on and restrain the ratchet arc 25 from sliding backward out of the pathway 221.

The linkage trigger 23 (FIG. 24, FIG. 25, FIG. 28) may have a similar to trigger shape longitudinal body comprising a hinge seat section 23a and a lever section 23b. The longitudinal edges 23k and 231 define the width of the linkage trigger 23. The hinge seat section 23a may further comprise a pair of transversely forked arms 23c and 23d generally symmetric to the plane EF (FIG. 25) forked from the lever section 23b and offset from the longitudinal edges 23k and 231, a bridge 23e bridging the pair of forked arms 23c and 23d on the top end width-wise to enhance the rigidity of the linkage trigger 23, a first bore hole 23f generally perpendicular to the plane EF and through the bridge 23e on the adjacent end to the lever section 23b to form a hinge seat to pivotally connect with the pair of hinge seats 22i and 22j on the second arm 22 via the second pin 29 and form a second pivot; a second bore hole 23g generally parallel to the first bore hole 23f and through the pair of forked arm 23c and 23d to form a pair of hinge seats to pivotally connect with the pawl 24 via a first pin 30 and form a third pivot, and a third bore hole 23h on the other end generally parallel to the first bore hole 23f and through the pair of the forked arms 22c and 22d to form another pair of hinge seats to stationarily receive a second pin 30 and form a rotation limit.

The pawl 24 (FIG. 24, FIG. 25, FIG. 29) may have a longitudinal body comprising a pawl head section 24a connected by a rotation limit section 24b. The longitudinal edges 24i and 24j define the width of the body. The pawl head section 24a may further comprise a lateral integral pawl face 24c consisting of a plurality of pawl teeth, a bore hole 24d generally perpendicular to the plane EF (FIG. 25) and though the pawl head section 24a to pivotally connect with the linkage trigger 23 on the third pivot via the coaxially aligned bore hole 23g and the first pin 30. The rotation limit section 24b may further comprise a curved slot 24f generally perpendicular to the plane EF and though the rotation limit section 24b to pivotally and slidably receive the second pin 30 that is fixed in the bore hole 23h. The slot 24f may further comprise a first arc surface 24g and a second arc surface 24h which are concentric to the axis A4 (FIG. 25), so that the pawl 24 may rotate around the axis A4 of the third pivot and the rotation range is limited within the slot 24f by the travel limit pin 30 and slot 24f mechanism. Therefore, the third pivot for the pawl 24 is a variable pivot, in that the third pivot may rotate around the second pivot, and the pawl may rotate around the third pivot. The variable pivot enables the pawl and ratchet engagement to self-adapt to the ratchet arc 25's movement resulted from the geometric deformation of the first and second arms 21 and 22 that is caused by the compressing force, so as to achieve the self-adaptive self-locking function.

The ratchet arc 25 (FIG. 24, FIG. 25, FIG. 30) may have a similar to arc shape longitudinal body comprising an anchor end 25a and a ratchet section 25b. The longitudinal edges 25g and 25h define the width of the body. The anchor end 25a having a bore hole 25c generally perpendicular to the plane EF (FIG. 25) is sized and shaped to be stationarily received into the recess 21i and anchored on the first arm 21 via the coaxially aligned bore holes 21j and 25c, and the first pin 29. The ratchet section 25b may further comprise a lateral arc surface 25d having a radius R5 that is centered on the axis A3 when assembled, a lateral arc integral ratchet face 25e having a radius R6 that is centered on the axis A3 when assembled (FIG. 25), and a transversely protruding stop ridge 25f at the end which in conjunction with the threshold 22m (FIG. 25) restrain the ratchet arc 25 from sliding backward out of the pathway 221. The ratchet section 25b is sized and shaped to smoothly slide through the pathway 23i and the pathway 221.

In the assembled form, the pair of pivot sections 21a and 22a in conjunction with the pin 28 form the first pivot and the fulcrum on the axis A3 (FIG. 25); the pair of jaw sections 21b and 22b pair up to form a pair of jaws with a variable elastic gap and a variable hard-toothed gap; the handle sections 21c and 22c pair up to form a pair of handles to exert compressing force; the ratchet arc 25 is affixed to the first arm 21 on the anchor end 25a via the first pin 29, and the ratchet section 25b is slidably received into the pathway 23i of the linkage trigger 23 and the pathway 221 of the second arm 22, and rests on the threshold 22m; the linkage trigger 23 is pivotally connected to the second arm 22 via the coaxially aligned bore holes 22k and 23f and the second pin 29, forming the second pivot, and is rotatable in the gap between the pair of hinge seats 22i and 22j, as well as in the pathway 221; the pawl 24 is pivotally connected to the linkage trigger 23 in the gap between the pair of forked arms 23c and 23d via the coaxially aligned bore holes 23g, 24d, and the first pin 30, and may rotate within the range of the slot 24f via the travel limit pin and slot mechanism formed by the second pin 30 and the slot 24f; and the compression spring 26 supported between the linkage trigger 23 and the second arm 22 exerts spring force on the linkage trigger 23 so that the linkage trigger 23 rotates away from the second arm 22 until the pawl 24 is fully engaged with the ratchet arc 25.

When a user exerts compressing force on the pair of handles, the ratchet arc 25 pushes up the pawl 24, resulting the linkage trigger 23 to rotate closer to the second arm 22 to disengage the pawl and ratchet engagement, while the second pin 30 in the bore hole 23h stays on the bottom of the slot 24f to restrain the pawl 24 from rotating on the axis A4 (FIG. 25) and enhance the stability of the relative movement; the ratchet arc 25 may slide forward further into the pathway 221, resulting in the gap of the pair of jaws to narrow. When the exerted compressing force is removed, the compression spring 26 pushes the linkage trigger 23 to rotate away from the second arm 22, forcing the pawl 24 to fully engage with the ratchet arc 25, and preventing the ratchet arc 25 from sliding backward. Therefore, the oil filter wrench is self-locked in a fixed position. When the linkage trigger 23 is pulled closer to the second arm 22, the pawl 24 is lifted up and the pawl and ratchet system disengages, allowing the pair of handles to move apart.

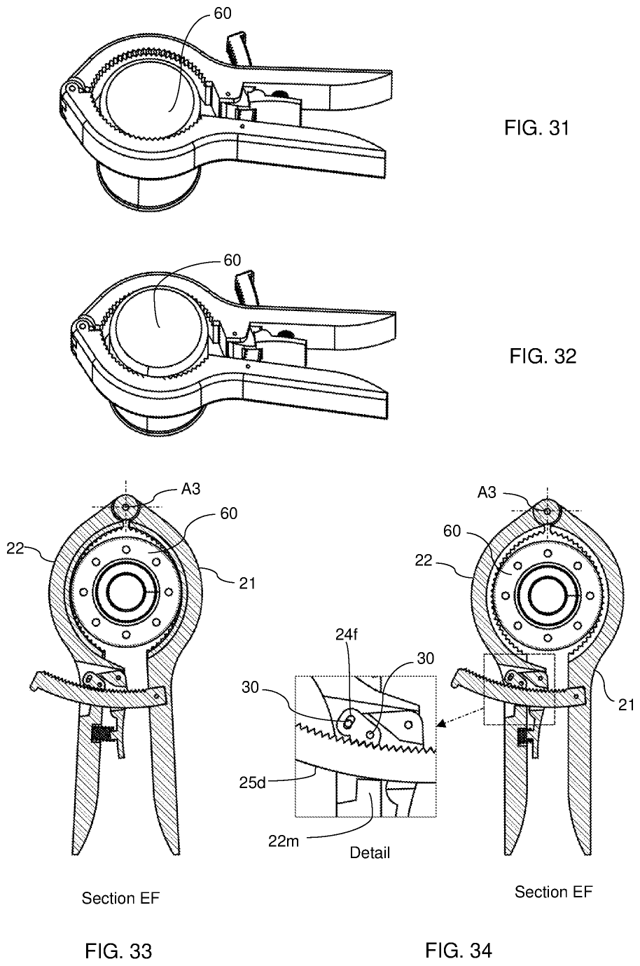

FIG. 31 illustrates how a user may operate the oil filter wrench to tighten an oil filter 60. The user may hand-tighten the oil filter 60 on the engine block first, then place the oil filter between the pair of elastic pads 27, and exert clamping force on the pair of handles. The clamping force forces the gap between the first and second arms 21 and 22 to narrow, resulting in the oil filter housing in contact with the pair of clamping pads 27. The user may further exert clamping force on the pair of handles to force the pair of elastic clamping pads 27 and the first and second 21 and 22 to deform, creating desirable clamping pressure on the oil filter 60 while reducing the possibility of damaging the oil filter housing. The user may then turn the pair of first and second arms 21 and 22, and utilize the resulting friction force exerted on the oil filter 60 to twist the oil filter for the last a quarter of a turn to finish the oil filter tightening process, while not having to keep exerting the clamping force.

FIG. 32 illustrates how the user may operate the oil filter wrench to loosen the oil filter 60. The user may place the oil filter 60 between the pair of clamping pads 27 and the pair of toothed arcs 21h and 22h, and exert clamping force on the pair of handles. The clamping force forces the gap between the first and second arms 21 and 22 to narrow, resulting in the oil filter housing in contact with the pair of toothed arcs 21h and 22h. The user may further exert clamping force on the pair of handles to force the teeth of the pair of toothed arcs 21h and 22h to dent into the oil filter housing, the pair of elastic clamping pads 27 and the first and second arms 21 and 22 to deform, creating a strong grip on the oil filter 60. The user may then turn the pair of first and second arms 21 and 22, and utilize the resulting friction force exerted on the oil filter 60 to turn and loosen the oil filter 60 from the engine block, while not having to keep exerting the clamping force.

FIG. 33 and FIG. 34 further illustrate how the self-adaptive self-locking mechanism works in the abovementioned oil filter loosening example of FIG. 32. FIG. 33 shows a hybrid projection view of the oil filter 60 and sectional view of the oil filter wrench of the FIG. 32 from the same plane EF on the FIG. 25 of an ideal situation, in which no geometric deformation occurs to both of the first and second arms 21 and 22. In such situation the clamping force forces the ratchet arc 25 to push up the pawl 24 to disengage the pawl from the ratchet arc 25, and slide along the threshold 22m in a circular motion in relation to the axis A3. When the clamping force is removed, the pawl 24 and the ratchet arc 25 are fully engaged, locking the pair of handles in a fixed position, and the third pivot settles in a position within the rotation range limited by the second pin 30 and the slot 24f.

FIG. 34 shows a hybrid projection view of the oil filter 60 and sectional view of the oil filter wrench of the FIG. 32 of a real-life situation, in which geometric deformation occurs to both of the first and second arm 21 and 22. In such situation the handle sections 21c and 22c are bent inwards, the ratchet arc 25 is tilted up away from the threshold 22m and the pawl 24 is pushed up, resulting in the linkage trigger 23 to rotate closer to the second arm 22 and the pawl 24 pivots on the third pivot in another position within the rotation range limited by the second pin 30 and the slot 24f, self-adapting to the ratchet arc 25's movement caused by the geometric deformation of both the first and second arms 21 and 22, while maintaining the pawl and ratchet engagement. Therefore, the majority of the previously exerted clamping energy is stored in the form of elastic deformation of the first and second arms 21 and 22, and the pair of clamping pads 27, and the strong grip on the underlining workpiece is maintained.

Working examples of abovementioned embodiments have proven the self-adaptive self-locking mechanisms provide exceptionally stable locking engagement when the clamping apparatus is undergoing significant geometric deformation.

1: A self-adaptive self-locking clamping apparatus comprising:
a first arm having a longitudinal curved body comprising a jaw section, a pivot section and a handle section;
a second arm having a longitudinal curved body comprising a jaw section, a pivot section and a handle section, wherein said handle section further comprises a transverse slotted cutout forming a pathway between two lateral surfaces of said handle section;
a ratchet arc having a longitudinal body comprising an anchor end and an arc shape ratchet section, wherein said ratchet section further comprises an arc shape lateral integral ratchet face having a constant radius on one side and a lateral arc surface on the other side, thereof said arc surface is significantly concentric to said integral ratchet face;
an integrated pawl trigger having a longitudinal body comprising a pivot section, an integrated pawl section and a lever section, wherein said integrated pawl section further comprises a transverse slotted pathway sized and shaped to slidably receive said ratchet arc, such that said pathway forms at least one integral pawl tooth to couple with said ratchet face and a compressing edge on the opposing side to grip on said arc surface, thereby creating a pawl and ratchet self-locking mechanism by engaging said at least one integral pawl tooth with said ratchet face and said compressing edge with said arc surface, whereas said lever section actuates disengagement of said pawl and ratchet self-locking mechanism;
an elastic member;
wherein said first arm is pivotally interconnected with said second arm on the respective pivot sections, forming a first pivot and a fulcrum, a pair of jaws with at least a variable gap to clamp on a workpiece, and a pair of handles to apply clamping force;
wherein said ratchet arc is stationarily anchored on and affixed to said handle section of said first arm on said anchor end having said ratchet section facing said second arm;
wherein said constant radius of said ratchet face is centered on the axis of said first pivot so that said ratchet arc is rotatable in relation to the axis of said first pivot in a path coinciding with the curve of said ratchet face;
wherein said integrated pawl trigger is pivotally connected to said second arm and facing said first arm via said pivot section forming a second pivot, thereof said second pivot is a variable pivot and is movable within a limited range generally along the longitudinal direction of said second arm;
wherein said ratchet arc is slidably received into said pathway of said integrated pawl trigger and said pathway of said second arm in a circular motion relative to the axis of said first pivot;
wherein said elastic member is supported between said integrated pawl trigger and said second arm to provide an elastic force to urge said integrated pawl trigger pivoting on said second pivot to rotate away from said second arm such that said compressing edge is stopped by and engaged with said arc surface and said at least one integral pawl tooth is stopped by and fully engaged with said ratchet face, forming a directional pawl and ratchet self-locking mechanism between said pair of handles, thereby said ratchet arc is only slidable when said pair of handles rotate towards each other by overcoming said elastic force such that said compressing edge and said at least one integral pawl tooth disengage from said arc surface and said ratchet face respectively, and is fully engaged with said integrated pawl trigger when no overcoming counter force to said elastic force exists to prevent said pair of handles from moving apart;
wherein in situation which no geometric elastic deformation caused by the clamping force applied to said pair of handles occurs to said first and second arms, said ratchet arc slides into said pathway of said integrated pawl trigger and said pathway of said second arm in a circular motion in relation to said first pivot such that the center of said constant radius of said ratchet face conforms to the axis of said first pivot, and when said ratchet arc is fully engaged with said integrated pawl trigger said second pivot settles in a position within said limited range;
wherein in situation which geometric elastic deformation caused by the clamping force applied to said pair of handles occurs to said first and second arms, said ratchet arc slides into said pathway of said integrated pawl trigger and said pathway of said second arm in a circular motion in relation to said first pivot such that the center of said constant radius of said ratchet face deviates from the axis of said first pivot, and when said ratchet arc is fully engaged with said integrated pawl trigger said second pivot self-adapts to the changes and settles in another position within said limited range;
Wherein said variable pivot between said integrated pawl trigger and said second arm in conjunction with said directional pawl and ratchet self-locking mechanism between said ratchet arc and said integrated pawl trigger form a self-adaptive self-locking mechanism when said first and second arms are deformed caused by the applied clamping force; and
Wherein when counter force is applied to said lever section of said integrated pawl trigger to overcome said elastic force, said integrated pawl trigger pivots on said second pivot and rotates closer to said second arm such that said compressing edge and said at least one integral pawl tooth disengage from said arc surface and said ratchet face, allowing said pair of handles to move apart.

2: The self-adaptive self-locking clamping apparatus of claim 1, wherein said first arm further comprises a body having a jaw section on one end, followed by a pivot section in the middle, followed by a handle section on the other end; wherein said second arm further comprises a body having a jaw section on one end, followed by a pivot section in the middle, followed by a handle section on the other end; and wherein said first arm is pivotally interconnected with said second arm on the respective pivot sections, forming a scissor linkage, a first pivot and a fulcrum in the middle, a pair of jaws to clamp on a load on one end, and a pair of handles to exert effort on the other end.

3: The self-adaptive self-locking clamping apparatus of claim 1, wherein said first arm further comprises a body having a pivot section on one end, followed by a jaw section in the middle, followed by a handle section on the other end; wherein said second arm further comprises a body having a pivot section on one end, followed by a jaw section in the middle, followed by a handle section on the other end; and wherein said first arm is pivotally interconnected with said second arm on the respective pivot sections, forming a first pivot and a fulcrum on one end, a pair of jaws to clamp on a load in the middle, and a pair of handles to exert effort on the other end.

4: A self-adaptive self-locking clamping apparatus comprising:
a first arm having a longitudinal curved body comprising a jaw section, a pivot section and a handle section;
a second arm having a longitudinal curved body comprising a jaw section, a pivot section and a handle section, wherein said handle section further comprises a transverse slotted cutout forming a pathway between two lateral surfaces of said handle section;
a ratchet arc having a longitudinal body comprising an anchor end and an arc shape ratchet section, wherein said ratchet section further comprises an integral arc shape lateral ratchet face having a constant radius on one side and a lateral arc surface on the other side, thereof said arc surface is significantly concentric to said integral ratchet face;
a pawl having a longitudinal body comprising a pawl head section and a rotation limit section, wherein said pawl head section further comprises a lateral integral pawl face to couple with said ratchet face and a pivoting means on which said integral pawl face and as such said pawl pivots, whereas said rotation limit section limits the rotation of said pawl in a limited range;
a linkage trigger having a longitudinal body comprising a transversely protruding pivot section and a lever section, wherein said lever section further comprises a transverse slotted cutout adjacent to and cutting into said pivot section such that said cutout forms a pathway to slidably receive said rachet arc and pivotally receive said pawl, and said pivot section further comprises a first pivoting means and a second pivoting means;
an elastic member;
wherein said first arm is pivotally interconnected with said second arm on the respective pivot sections, forming a first pivot and a fulcrum, a pair of jaws with at least a variable gap to clamp on a workpiece, and a pair of handles to apply clamping force;
wherein said ratchet arc is stationarily anchored on and affixed to said handle section of said first arm on said anchor end having said ratchet section facing said second arm;
wherein said constant radius of said ratchet face is centered on the axis of said first pivot so that said ratchet arc is rotatable in relation to the axis of said first pivot in a path coinciding with the curve of said ratchet face;
wherein said linkage trigger is pivotally connected to said second arm and facing said first arm via said first pivoting means, forming a second pivot;
wherein said pawl is pivotally connected to said linkage trigger via said pivoting means of said pawl and said second pivoting means of said linkage trigger forming a third pivot, thereof said third pivot is a variable pivot and is rotatable around said second pivot while said pawl is rotatable around said third pivot within said limited range restricted by said rotation limit section;
wherein said ratchet arc is slidably received into said pathway of said linkage trigger and said pathway of said second arm and is slidable in a circular motion relative to the axis of said first pivot;
wherein said elastic member is supported between said linkage trigger and said second arm to provide an elastic force to urge said linkage trigger pivoting on said second pivot to rotate away from said second arm such that said pawl is stopped by and fully engaged with said ratchet arc, forming a directional pawl and ratchet self-locking mechanism between said pair of handles, thereby said ratchet arc is only slidable when said pair of handles rotate towards each other by overcoming said elastic force such that said pawl disengages from said ratchet arc, and is fully engaged with said pawl when no overcoming counter force to said elastic force exists to prevent said pair of handles from moving apart;
wherein in situation which no geometric elastic deformation caused by the clamping force applied to said pair of handles occurs to said first and second arms, said ratchet arc slides into said pathway of said linkage trigger and said pathway of said second arm in a circular motion in relation to said first pivot such that the center of said constant radius of said ratchet face conforms to the axis of said first pivot, and when said ratchet arc is fully engaged with said pawl said third pivot settles in a position while said pawl also rotates and settles in a position within said limited range;
wherein in situation which geometric elastic deformation caused by the clamping force applied to said pair of handles occurs to said first and second arms, said ratchet arc slides into said pathway of said linkage trigger and said pathway of said second arm in a circular motion in relation to said first pivot such that the center of said constant radius of said ratchet face deviates from the axis of said first pivot, and when said ratchet arc is fully engaged with said pawl said third pivot self-adapts to the changes and settles in another position while said pawl also rotates and settles in another position within said limited range;
wherein said variable pivot between said pawl and said linkage trigger in conjunction with said directional pawl and ratchet self-locking mechanism between said pawl and said ratchet arc form a self-adaptive self-locking mechanism when said first and second arms are deformed caused by the applied clamping force; and
wherein when counter force is applied to said lever section of said linkage trigger to overcome said elastic force, said linkage trigger pivots on said second pivot and rotates closer to said second arm such that said pawl disengages from said ratchet arc, allowing said pair of handles to move apart.

5: The self-adaptive self-locking clamping apparatus of claim 4, wherein said first arm further comprises a body having a jaw section on one end, followed by a pivot section in the middle, followed by a handle section on the other end; wherein said second arm further comprises a body having a jaw section on one end, followed by a pivot section in the middle, followed by a handle section on the other end; and wherein said first arm is pivotally interconnected with said second arm on the respective pivot sections, forming a scissor linkage, a first pivot and a fulcrum in the middle, a pair of jaws to clamp on a load on one end, and a pair of handles to exert effort on the other end.

6: The self-adaptive self-locking clamping apparatus of claim 4, wherein said first arm further comprises a body having a pivot section on one end, followed by a jaw section in the middle, followed by a handle section on the other end; wherein said second arm further comprises a body having a pivot section on one end, followed by a jaw section in the middle, followed by a handle section on the other end; and wherein said first arm is pivotally interconnected with said second arm on the respective pivot sections, forming a first pivot and a fulcrum on one end, a pair of jaws to clamp on a load in the middle, and a pair of handles to exert effort on the other end.
